(19) United States
(12) Patent Application Publication
(10) Pub. No.: US 2018/0002156 A1
(43) Pub. Date: Jan. 4, 2018

(54) SADDLE GIRTH

(71) Applicant: IKONIC SADDLERY, Lasne (BE)

(72) Inventor: OZAN TOLGA AKSOYEK, OHAIN (BE)

(21) Appl. No.: 15/629,930

(22) Filed: Jun. 22, 2017

(30) Foreign Application Priority Data
Jun. 29, 2016 (EP) 16176899.9

(51) Int. Cl. B68C 1/14; B68B 5/06; B68B 7/00; B68C 1/00

(52) U.S. Cl. CPC B68C 1/14; B68B 7/00; B68B 5/06; B68C 2001/007

(57) ABSTRACT

A saddle girth for equestrian use and comprising a central portion for contacting an abdomen of a horse; two lateral portions located at two opposite sides of said central portion for mechanically coupling said saddle girth to a saddle. The saddle girth is characterized in that it further comprises an extension portion extending from said central portion for passing between the two forelegs of a horse and for mechanically coupling said saddle girth to an equestrian element aimed to be placed above the two forelegs of a horse and in that said extension portion has a rounded external contour.

### TECHNICAL FIELD

The invention relates to the field of horse riding. More precisely, the invention relates to a saddle girth in the field of horse riding equipment.

### PRIOR ART

A saddle girth or saddle strap is a piece of riding equipment known by the one skilled in the art.

It is generally used to keep a saddle in place on a horse or other animals. The saddle girth mechanically couples with the saddle for allowing the tightening of said saddle on a horse.

A saddle girth or strap is also a protection for a horse belly from injuries caused by forelegs coming in contact with it during jumps.

A saddle girth is a main security element for the horse rider because the upkeep of the saddle is crucial for preventing the horse rider to fall. However, in some horse riding disciplines involving obstacles (for example show jumping, trail riding or steeplechasing) or speed (for example polo, fox hunting), the saddle girth is not sufficient for preventing the saddle from sliding back. In such circumstances, an equestrian element aimed to be placed above the two forelegs of a horse and which generally surrounds the neck of a horse is often connected to the saddle and to the saddle girth. Said equestrian element has generally the shape of a belt and is for example a breastplate (or a breastcollar, breaststrap, breastgirth, martingale).

Said equestrian element is then mechanically coupled to the saddle girth by the use of a bridle passing between the two forelegs of a horse and coupling said equestrian element and said saddle girth. The mechanical coupling of said bridle to the saddle girth is generally done by means of a snap hook. The bridle is mechanically coupled to said equestrian element, for example with a snap hook, with a buckle or is permanently connected to the equestrian element.

In disciplines requiring said equestrian element (for instance in jumping disciplines) a main drawback of the described prior art is identified.

During jumps, a foreleg of a horse can touch the bridle connecting the saddle strap to the equestrian element. Possibly, one foreleg can tangle with said bridle or with the connection means used for mechanically coupling the bridle with the saddle strap. This prevents a horse from stretching at least one of its foreleg for ensuring a proper landing and in fine causes the fall of a horse and a horse rider. The consequences of falling in said circumstances often lead to serious and irreversible injuries of a horse and a horse rider.

### SUMMARY OF THE INVENTION

One object of the invention is to provide a saddle girth that reduces the risks of a fall of a horse. To this end the inventor proposes a saddle girth comprising:
a central portion for contacting an abdomen of a horse;
two lateral portions located at two opposite sides of said central portion for mechanically coupling said saddle girth to a saddle;
   characterized in that:
said saddle girth further comprises an extension portion extending from said central portion for passing between two forelegs of a horse and for mechanically coupling said saddle girth to an equestrian element aimed to be placed above said two forelegs of a horse, and in that
said extension portion has a rounded external contour.

The invention provides a saddle girth which comprises an extension portion that has a rounded shape/contour. The unintentional mechanical coupling of a foreleg in contact with the extension portion is reduced thanks to its rounded external contour because the rounded shaped extension portion shows no rough spot (for instance topstitched seams, right or sharp angles due to a rectangular or flat cross section). The relative smoothness of the rounded shaped extension portion compared to a bridle as referred to in the prior art causes the foreleg to slide on the rounded shape instead of coupling mechanically with a rough spot of said bridle. The invention provides the horse and horse rider a safer riding equipment.

Said unintentional mechanical coupling between a foreleg and said bridle can happen in several ways. Preferably between a foreleg and a connecting mean between the saddle girth and the bridle, for example a sharp edge of a snap hook and a sharp edge of a horseshoe. Another possible cause for said unintentional mechanical coupling is a mechanical coupling of the forelegs with a portion of said bridle, for example a seam of said equestrian element with a sharp edge of a horseshoe. Another possible cause is a foreleg passing between said bridle and a horse body resulting to a mechanical coupling when the horse stretches back its forelegs.

The groom or horse rider does not need to go under the horse for connecting a bridle from said equestrian element to the saddle girth (for example with a snap hook) because the saddle girth comprises an extension portion for passing between the two forelegs and for mechanically coupling the saddle girth to the equestrian element (belt for instance).

The central portion of the saddle girth is in contact with the abdomen, the belly or the barrel of a horse. The two lateral portions of the saddle girth can also be defined as two elongated members.

The saddle girth of the invention could also be named girth or saddle girth.

Said equestrian element as stated in the prior art is connected to the saddle girth by means of a bridle at the level of said central portion. In the invention, said equestrian element is connected to the extension portion. The connection of the extension portion with said equestrian element is made preferably at the level of the chest of the horse. The connection of the extension portion to the equestrian element can be done by means of a bridle which can be connected to the extension portion and to the equestrian element.

Said equestrian element is for example a belt, a breastplate, a breastcollar, a breaststrap, a breastgirth, a martingale. Said equestrian element preferentially surrounds at least partially the neck of a horse.

Moreover, as the saddle girth comprises such an extension portion, it is not necessary to provide means for mechanically coupling a bridle to the saddle girth such as a snap hook. The absence of such a snap hook also reduces the risks of a fall of a horse as its forelegs have less chances to be blocked.

The inventors propose several preferred embodiments comprising optional features; some of them can be combined as reflected by the claims dependencies.

Preferably, the extension portion has a deformable (or variable) cross-section. An associated advantage of said extension portion having a deformable cross-section is that it can adapt more easily to horse morphologies and sizes. Another advantage is related to the comfort of a horse because the extension portion can better follow the motion of a horse. Another advantage relating to safety and aesthetic is that the extension portion due to its deformability is better pinned to the horse chest.

For example, the extension portion has an elliptic cross-section.

For example, the extension portion has a circular cross-section.

Preferably, the extension portion is sewn to said central portion. An alternative way for mechanical coupling of said central portion to said extension portion involves the use of VELCRO®.

Preferably, the extension portion is permanently connected to said central portion. The permanent connection of said extension portion with said central part implies that the mechanical uncoupling of said extension portion from said central part affects the integrity of the saddle girth. An associated advantage of the extension portion being permanently connected to said central portion is that it is more robust because it does not involve detachable portions. Another associated advantage is that it is easier to produce essentially because there is no detachable connection mean between said central part and the extension portion. Another associated advantage is that the fabrication process is very similar to the fabrication process of a saddle girth and may only require little adjustments of it.

Preferably, said central portion, said two lateral portions, and said extension portion are parts of a same body.

Preferably, said extension portion comprises a cavity. An associated advantage of said extension portion comprising a cavity is to allow a better deformability of said extension portion. Because said extension portion can better deform, said extension portion can better hug the horse chest. The better contact of said extension portion with the horse skin reduces the risk of horse fall by an unintentional mechanical coupling.

Preferably, an opening in communication with said cavity is located on an external surface of said extension portion. Said cavity opening allows receiving at least a portion of a bridle. By receiving a portion of a bridle, the equestrian element is made safer and more aesthetic.

### BRIEF DESCRIPTION OF THE FIGURES

These aspects of the invention as well as others will be explained in the detailed description of specified embodiments of the invention, with reference to the drawings in the figures, in which:

FIG. 1 shows an exemplary embodiment of a saddle girth according to the invention;

FIG. 2 shows a view of a horse equipped with an exemplary embodiment of a saddle girth according to the invention;

FIG. 3 shows an exemplary embodiment of a saddle girth according to the invention, where the extension portion comprises a cavity and an opening in communication with it;

The drawings in the figures are not to scale. Generally, similar elements are designated by similar reference signs in the figures. The presence of reference numbers in the drawings is not to be considered limiting, even when such numbers are also included in the claims.

### DETAILED DESCRIPTION OF POSSIBLE EMBODIMENTS OF THE INVENTION

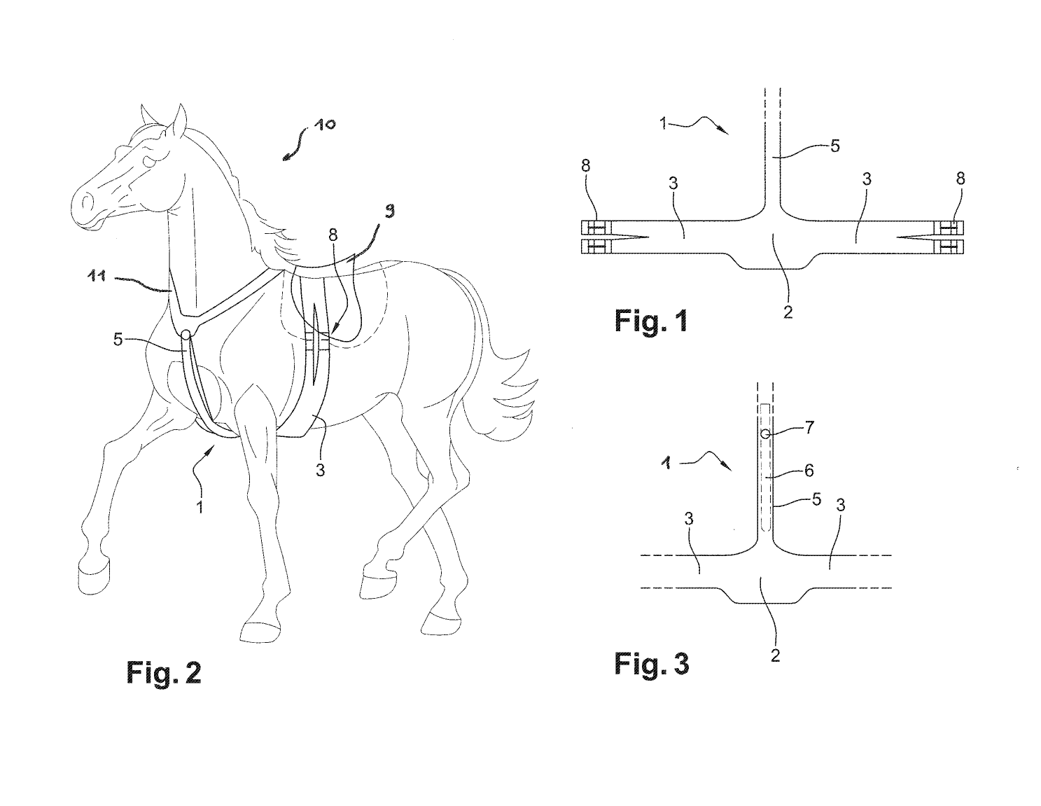

FIG. 1 shows an exemplary embodiment of the saddle girth 1 according to the invention. FIG. 2 shows a horse 10 equipped with a possible embodiment of the saddle girth 1 and with a saddle 9. The saddle girth comprises a central portion 2 which is aimed to be in contact with the belly of a horse 10. Central portion 2 of the saddle girth 1 is preferably made of leather, for example two layers of leather are sewn to form a double layered structure. One of the layer of the double layered structure gives softness to the central portion 2, for the side in contact with the belly of a horse 10 and another layer gives more stiffness to the central portion 2. Central portion 2 has a flexibility high enough for adapting to different sizes of horses.

The saddle girth 1 comprises two lateral portions 3 located at two opposite sides of said central portion 2. The two lateral portions 3 and the central portion 2 are preferably parts of a same body and made of a same continuous piece of leather as the central portion 2. According to another possible embodiment, the two lateral portions 3 are separated elements which are attached to the central portion 2, preferably by sewing. The saddle girth 1 is aimed to be coupled mechanically to a saddle 9 by means of the two lateral portions 3 (see FIG. 2). The two lateral portions 3 generally have connecting means 8 at their two ends. For example said connecting means 8 are buckles or rollers buckles. Generally the connecting means 8 are mechanically coupled to the lateral portions 2 with an extensible material other than leather, the buckles are preferably coupled to the extensible material with a piece of leather passing inside the buckle and sewn onto the extensible material on its both sides. Preferably each lateral portion 3 is equipped with a ring for connection of other equestrian elements.

The saddle girth 1 comprises an extension portion 5 which is preferably part of a same body formed by the central portion 2 and the two lateral portions 3. According to a possible embodiment, all the different parts (2, 3, 5) of the saddle girth 1 are made of a same continuous piece of leather. According to another possible embodiment, the extension portion 5 is permanently fixed, for instance by means of sewing, to the central portion 2. The extension portion 5 is aimed to couple with an equestrian element 11 (belt for instance) that preferentially surrounds at least partially the neck of a horse 10. For example, in addition of being connected to the saddle girth 1, said equestrian element 11 is connected to the saddle 9 or is connected to the reins of a horse. For example said equestrian element 11 is a breastplate, a breastcollar, a breaststrap, a breastgirth or a martingale. Preferably the extension portion 5 has connecting means at its end which is a buckle. Another embodiment of said connecting means of the extension portion 5 is a belt element which is connected in a buckle comprised preferably in said equestrian element 11. The extension portion 5 has a rounded shape. The rounded shape of the extension portion 5 is preferably obtained by sewing the two long edges of the extension portion 5 piece of leather. The extension portion 5 rounded shape can be characterized by its outer perimeter which is obtained by taking a cross-section (perpendicular to the surface of the extension portion 5) of the extension portion 5 and by measuring the contour of the shape obtained. The extension portion 5 outer perimeter is preferably comprised between 5 and 25 cm, more preferably between 6 and 15 cm and still more preferably in the range of 8 to 10 cm. Preferably the outer perimeter of the extension portion 5 varies alongside said extension portion 5. Preferably the outer perimeter of said extension portion 5 is larger at a portion close to the central portion 2 than at a portion which is aimed to connect with the equestrian element 11. For example the outer perimeter of said extension portion 5 is 10 cm at the side of the central portion 2 and 8 cm at the side of the connecting mean.

FIG. 2 shows a schematic three quarter view of a horse 10 equipped with an exemplary embodiment of the invention. FIG. 2 shows the embodiment of the invention with the central portion 2 placed against the belly of a horse 10. The two lateral portions 3 are placed against the flanks and are connected to the saddle 9. The extension portion 5 passes between the forelegs and goes along the chest. The extension portion 5 is connected to said equestrian element 11 which preferably surrounds at least partially the neck of a horse 10. The equestrian element 11 which can be connected to said extension portion 5 is for example a breastplate, a breastcollar, a breastgirth, a breaststrap, a martingale and is not limited to the cited elements. Preferably the extension portion 5 is pinned to the chest and between the forelegs. The shape of said extension portion 5 is rounded and preferably deformable, so it hugs the belly of the horse and the chest as good as possible.

FIG. 3 shows a preferred embodiment of the saddle girth 1. According to this preferred embodiment, the extension portion 5 comprises a cavity 6. Preferably the cavity 6 is located alongside the inside of said extension portion 5. The cavity ends are preferably located at the mechanical coupling with said central portion 2 and at said portion which is aimed to connect with said equestrian element. The cavity perimeter is preferably comprised between 3.5 and 23.5 cm, more preferably between 4.4 and 13.5 cm and still more preferably in the range of 6.3 to 8.5 cm. The cavity perimeter and the extension portion outer perimeter are preferably linked and are possibly dependant of the leather thickness used for the extension element 5.

Said cavity 6 comprised in the extension element 5, leads preferably to an opening 7 located on an external surface of said extension portion 5. Said opening 7 of said cavity 6 preferably allows receiving a portion of a bridle that is preferably used for the connection of the extension portion 5 with said equestrian element 11. By receiving a portion of a bridle, the equestrian element 11 is made safer and more aesthetic.

Said extension portion (5) has a length preferably comprised between 20 and 100 cm, more preferably comprised between 40 cm and 80 cm, and still more preferably of 50 cm.

The present invention has been described with reference to a specific embodiments, the purpose of which is purely illustrative, and they are not to be considered limiting in any way. In general, the present invention is not limited to the examples illustrated and/or described in the preceding text. Use of the verbs “comprise”, “include”, “consist of”, or any other variation thereof, including the conjugated forms thereof, shall not be construed in any way to exclude the presence of elements other than those stated. Use of the indefinite article, “a” or “an”, or the definite article “the” to introduce an element does not preclude the presence of a plurality of such elements. The reference numbers cited in the claims are not limiting of the scope thereof.

In summary, the invention may also be described as follows. Saddle girth 1 for equestrian use and comprising a central portion 2 for contacting an abdomen of a horse 10; two lateral portions 3 located at two opposite sides of said central portion 2 for mechanically coupling said saddle girth 1 to a saddle 9. The saddle girth 1 is characterized in that it further comprises an extension portion 5 extending from said central portion 2 for passing between the two forelegs of a horse 10 and for mechanically coupling said saddle girth 1 to an equestrian element 11 aimed to be placed above the two forelegs of a horse 10 and in that said extension portion 5 has a rounded external contour.

All fastening elements other than the connecting means 8 are removed from the saddle girth 1. Elements such as straps, buckles and metallic or plastic elements which usually enable the connection of a breastplate to a classical saddle strap are removed. The risks of unintentional mechanical coupling of a horse foreleg and the saddle girth of the invention during a jump are reduced.

1. Saddle girth for equestrian use and comprising:
a central portion for contacting an abdomen of a horse;
two lateral portions located at two opposite sides of said central portion for mechanically coupling said saddle girth to a saddle; and
an extension portion extending from said central portion for passing between two forelegs of a horse and for mechanically coupling said saddle girth to an equestrian element aimed to be placed above said two forelegs of a horse, wherein said extension portion has a rounded external contour.

2. Saddle girth according to claim 1 wherein said extension portion has a deformable cross-section.

3. Saddle girth according to claim 1 wherein said extension portion has an elliptic cross-section.

4. Saddle girth according to claim 1 wherein said extension portion has a circular cross-section.

5. Saddle girth according to claim 1 wherein said extension portion is sewn to said central portion.

6. Saddle girth according to claim 1 wherein said extension portion is permanently connected to said central portion.

7. Saddle girth according to claim 1 wherein said central portion, said two lateral portions, and said extension portion are parts of a same body.

8. Saddle girth according to claim 1 wherein said extension portion defines a cavity.

9. Saddle girth according to claim 8 wherein an external surface of said extension portion defines an opening in communication with said cavity, for receiving at least a portion of a bridle.

10. Saddle girth according to claim 1 wherein said extension portion has a length of between 20 cm and 100 cm.

11. Saddle girth according to claim 10 wherein said extension portion has a length of between 40 cm and 80 cm.

12. Saddle girth according to claim 11 wherein said extension portion has a length of 50 cm.
